(19) United States
(12) Patent Application Publication
(10) Pub. No.: US 2026/0101404 A1
(43) Pub. Date: Apr. 9, 2026

(54) Enhanced UE Processing Logic of RRC Reconfiguration

(71) Applicant: Apple Inc., Cupertino, CA (US)

(72) Inventors: Zhiwei WANG, Beijing (CN); Fangli XU, Beijing (CN); Junzhen QIN, Beijing (CN); Lijie ZHANG, Beijing (CN); Shuang WANG, Beijing (CN); Yuqin CHEN, Beijing (CN)

(21) Appl. No.: 19/103,985

(22) PCT Filed: Aug. 17, 2022
(86) PCT No.: PCT/CN2022/112992

§ 371 Date: Feb. 14, 2025

(51) Int. Cl. H04W 76/20; H04W 76/19

(52) U.S. Cl. CPC H04W 76/20; H04W 76/19

(57) ABSTRACT

A user equipment configured to receive a first Radio Resource Control (RRC) Reconfiguration message comprising a full configuration from a currently camped cell, transmit a RRC Reconfiguration Complete message to the currently camped cell, receive, prior to sending the RRC Reconfiguration Complete message, a second RRC Reconfiguration message and ignore the second RRC Reconfiguration message received from the currently camped cell that was received prior to sending the RRC Reconfiguration Complete message.

### BACKGROUND

Field observations have revealed that 5G New Radio (5G NR) may send a Radio Resource Control (RRC) reconfiguration with a full configuration before a user equipment (UE) has replied with an RRC Reconfiguration Complete message. This behavior has been observed when a UE attempts to re-establish a connection when moving between gNBs.

The processing of a full configuration requires the UE to reset a signaling radio bearer (SRB) radio link control (RLC) secondary node (SN) to 0. This may potentially cause a RLC SN mismatch between the UE and gNB when there is an RLC retransmission on the SRB. Improved UE processing logic of RRC Reconfiguration is needed to avoid a potential RRC connection release by the network.

### SUMMARY

Some exemplary embodiments are related to a processor of user equipment configured to receive a first Radio Resource Control (RRC) Reconfiguration message comprising a full configuration from a currently camped cell, transmit a RRC Reconfiguration Complete message to the currently camped cell, receive, prior to sending the RRC Reconfiguration Complete message, a second RRC Reconfiguration message and ignore the second RRC Reconfiguration message received from the currently camped cell that was received prior to sending the RRC Reconfiguration Complete message.

Other exemplary embodiments are related to a user equipment (UE) having a transceiver configured to communicate with a currently camped cell and a processor configured to receive a first Radio Resource Control (RRC) Reconfiguration message comprising a full configuration from the currently camped cell, transmit a RRC Reconfiguration Complete message to the currently camped cell, receive, prior to sending the RRC Reconfiguration Complete message, a second RRC Reconfiguration message and ignore the second RRC Reconfiguration message received from the currently camped cell that was received prior to sending the RRC Reconfiguration Complete message.

Still further exemplary embodiments are related to a processor of a user equipment (UE) configured to receive a first Radio Resource Control (RRC) Resume message comprising a full configuration from a currently camped cell, transmit a RRC Reconfiguration Complete message to the currently camped cell, receive, prior to sending the RRC Reconfiguration Complete message, an RRC reconfiguration message and ignore the RRC reconfiguration message received from the currently camped cell that was received prior to sending the RRC Reconfiguration Complete message.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows an exemplary call flow for UE processing logic of RRC Reconfiguration according to various exemplary embodiments.

FIG. 5 shows an exemplary call flow for improved UE processing logic of RRC Reconfiguration according to various exemplary embodiments.

### DETAILED DESCRIPTION

The exemplary embodiments may be further understood with reference to the following description and the related appended drawings, wherein like elements are provided with the same reference numerals. The exemplary embodiments relate to improved handling of RRC Reconfiguration messages received by a UE. A UE that processes a full configuration may experience RLC SN mismatch with the gNB when there is no RLC retransmission on the SRB.

The exemplary embodiments describe the improved RRC Reconfiguration processing logic of the UE. A UE that ignores any additionally received RRC messages before transmitting an RRC reconfiguration complete message may avoid the network dropping the RRC connection with the UE.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network that assigns, in an unsecured manner, an identifier to a device that is using the network.

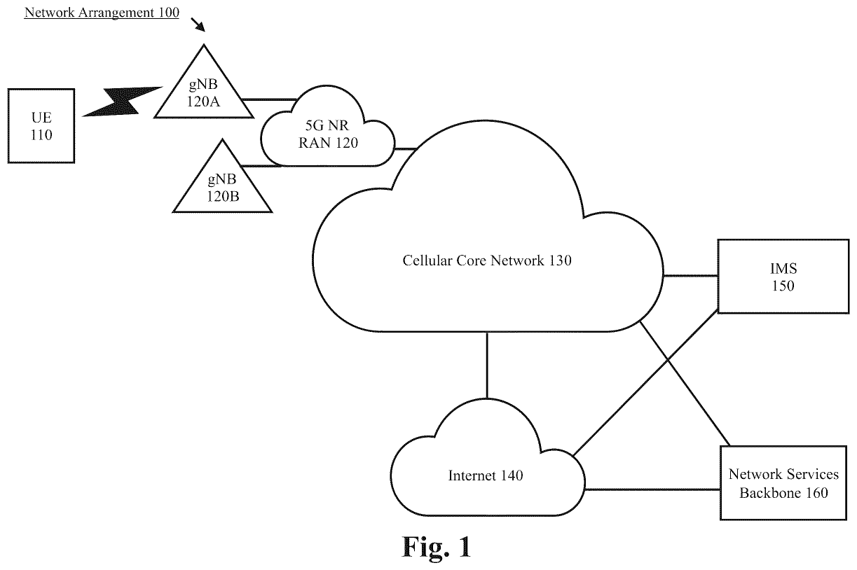

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A and gNB 120B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A or gNB 120B).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

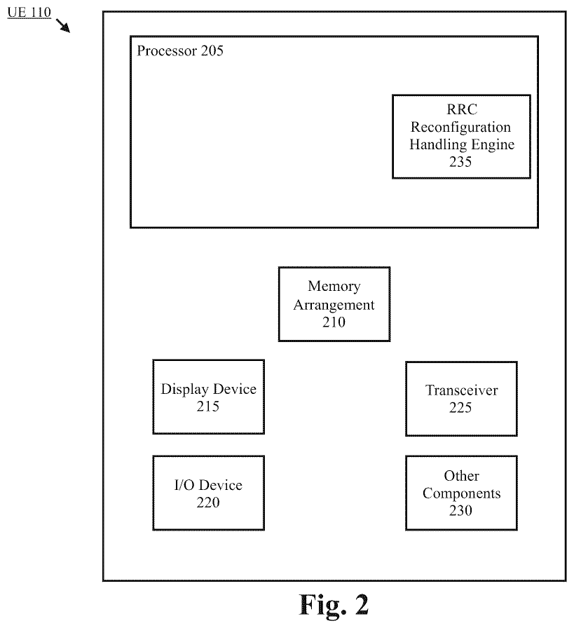

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an RRC reconfiguration handling engine 235 for performing operations including evaluating whether an RRC reconfiguration has been received and whether to ignore additional RRC reconfigurations until an RRC reconfiguration received message is sent to the network.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies). For example, the transceiver 225 may operate on the unlicensed spectrum when e.g., NR-U is configured.

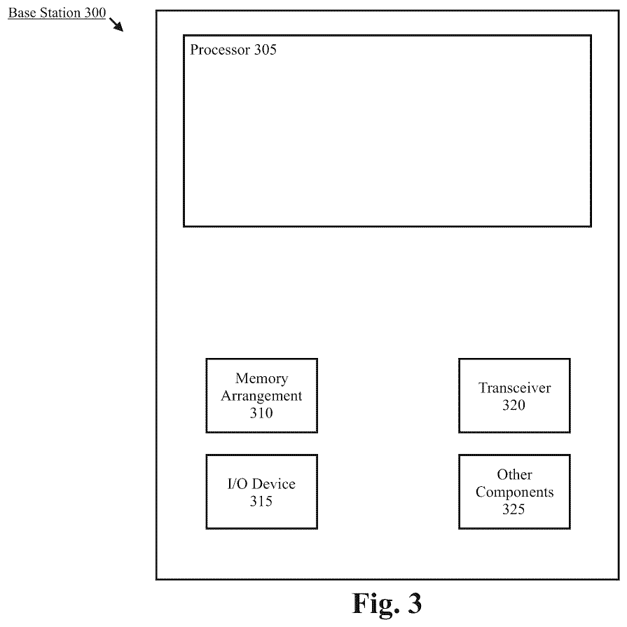

FIG. 3 shows an exemplary base station 300 according to various exemplary embodiments. The base station 300 may represent the gNB 120A or gNB 120B or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

Existing UE handling of full RRC Reconfiguration may result in a mismatch between the UE and the gNB when there is RLC retransmission on the SRB. This mismatch may result in the network dropping the UE RRC connection.

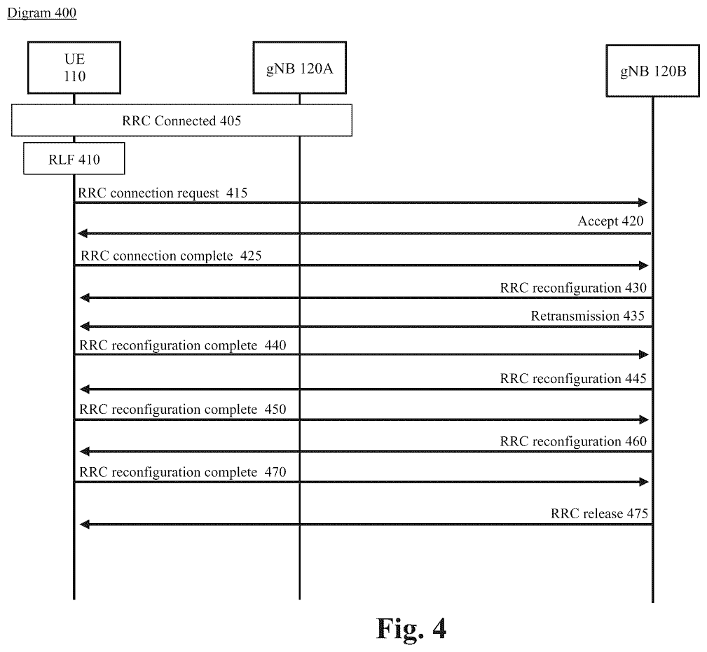

FIG. 4 shows an exemplary call flow for UE handling of RRC Reconfiguration according to various exemplary embodiments. A UE (e.g., UE 100) begins the timing diagram in the RRC connected state at 405. The UE 110 begins connected to gNB 120A. At a later point in time, a radio link failure (RLF) occurs. The UE 110 then attempts to reestablish RLC, medium access control (MAC), and/or the physical layer (PHY) with gNB 120A.

Should the attempts at reestablishing a connection with gNB 120A fail, at 415, the UE 110 sends an RRC reestablishment request to gNB 120B. At 420, gNB 120B responds to UE 110, accepting the request, with the RRC reestablishment PDCP SN=0. At 425, the UE 110 transmits an RRC reestablishment complete message to the gNB 120B.

At 430, the gNB 120B transmits an RRC Reconfiguration (with a full configuration) to the UE 110. This reconfiguration has RRC TI=2, the RLC SN=1, and the PDCP SN=1. The UE 110 requires substantial time (on the order of 50 milliseconds) to process the received full configuration. During this period, the gNB 120B may retransmit an RLC RRC reconfiguration with full configuration, to be discussed below.

At 435, the gNB 120B may transmit an RLC retransmission of the RRC reconfiguration (with a full configuration). This may be caused by a high block error rate (BLER) or from multiple SIM (MSIM) tune away, or because no uplink (UL) grants have been provided. Any the of preceding reasons may cause a RLC poll timer to expire, which may cause retransmission to rectify the issue. The gNB 120B sends RLC SN=1 and the PDCP SN=1.

Immediately preceding 435, the UE 110 flushes the RLC, and attempts to reestablish the RLC/MAC/PHY according to existing 3GPP standards. The UE 110 will treat the received RLC SN=1 as a new RLC packet. This presents an issue because this packet cannot be delivered to RRC because its PDCP SN equals 1, which is old.

Subsequently, when real RRC data with RLC SN=1 at operation 460 (described below) arrives, the UE 110 ignores this real RLC packet because it is considered to be old data by the UE 110. Eventually this causes the RRC to drop because the gNB 120B failed to receive the RRC reconfiguration complete message in 470 (described below).

At 440, the UE 110 sends an RRC reconfiguration complete message to the gNB 120B and with RRC TI=2. The gNB 120B proceeds to flush the RLC queue.

At 445, the gNB 120B transmits an RRC reconfiguration, with RRC TI=3, RLC SN=0 (due to the recent RLC queue flush), and PDCP SN=2. The UE 110 responds at 450 with an RRC reconfiguration complete message with TI=3.

At 460, the gNB 120B transmits an RRC reconfiguration to the UE 110, with RRC TI=0, RLC SN=1, and PDCP SN 3. The UE RLC drops this SN 1. The UE 110 operates under the logic that this is a retransmission of 435, and not a new message.

At 470, the UE 110 transmits an RRC reconfiguration complete message to the gNB 120B, with RRC TI=0, without updating the RLC SN. Approximately 8 seconds later, the gNB 120B releases the UE 110 at 475 because the UE 110 failed to send an RRC reconfiguration complete message to the gNB 120B.

One of skill in the art will recognize that a UE that receives a full configuration in an RRC Reconfiguration message should avoid the release scenario described above in 475. This may be avoided if the UE ignores any new RRC Reconfiguration (and other RRC messages in SRB1) after receiving the first RRC Reconfiguration with full-configuration and before the UE responds with the RRC Reconfiguration Complete message.

A similar logic may be applied for the RRC resume procedure, or any procedures in which the UE has just reset the RLC/MAC/PHY.

The proposed logic addresses potential RLC SN mismatch between the UE and gNB. The proposed logic avoids the potential release of the RRC connection by the network.

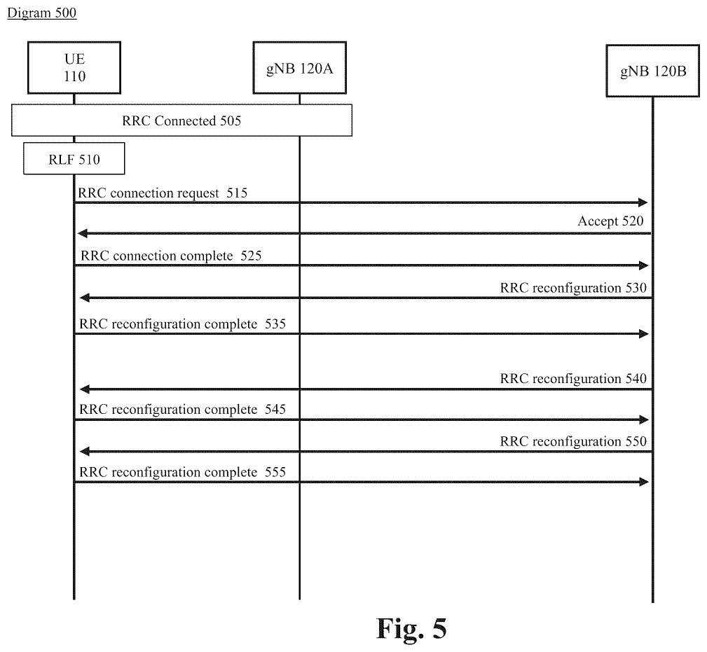

FIG. 5 shows an exemplary timing diagram for improved UE processing logic of RRC Reconfiguration according to various exemplary embodiments.

505-525 are substantially similar to the operations 405-425 discussed above. At 530, gNB 120B sends an RRC reconfiguration request with full configuration to the UE 110. This RRC reconfiguration request has the RRC TI=2, and RLC SN=1. Critically, the UE 110 now ignores any RB1 RLC SN that is not 0. This avoids the issue presented in FIGS. 4, 435 that Causes a RLC SN mismatch.

In 535, the UE 110 sends an RRC Reconfiguration Complete message to the gNB 120B, with RRC TI=2. The gNB 120B flushes the RLC queue. In 540, the gNB 120B sends another RRC reconfiguration request, with RRC TI=3, and RLC SN=0. In 545, the UE 110 responds with an RRC reconfiguration complete message with RRC TI=3. In 550, gNB 120B sends another RRC reconfiguration, with RRC TI=0, and RLC SN=1. In 555, the UE 110 responds with another RRC Reconfiguration Complete message, with RRC TI=0. The RRC connections continues in this manner.

Ignoring any RLC SN that is not=0 allows for the UE 110 to avoid the RLC SN mismatch described with respect to FIG. 4. As discussed above, an RLC SN mismatch may lead to the gNB 120B releasing the UE 110 RRC connection.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of user equipment configured to:
receive a first Radio Resource Control (RRC) Reconfiguration message comprising a full configuration from a currently camped cell;
transmit a RRC Reconfiguration Complete message to the currently camped cell;
receive, prior to sending the RRC Reconfiguration Complete message, a second RRC Reconfiguration message; and
ignore the second RRC Reconfiguration message received from the currently camped cell that was received prior to sending the RRC Reconfiguration Complete message.

2. The processor of claim 1, further configured to:
process the full configuration in the first RRC Reconfiguration message prior to sending the RRC Reconfiguration Complete message.

3. The processor of claim 2, wherein the full configuration resets a radio link control (RLC) signaling radio bearer (SRB) for a secondary node (SN).

4. The processor of claim 1, further configured to:
receive, prior to sending the RRC Reconfiguration Complete message, a third RRC Reconfiguration message; and
ignore the third RRC Reconfiguration message received from the currently camped cell that was received prior to sending the RRC Reconfiguration Complete message.

5. A user equipment (UE), comprising:
a transceiver configured to communicate with a currently camped cell; and
a processor configured to:
receive a first Radio Resource Control (RRC) Reconfiguration message comprising a full configuration from the currently camped cell;
transmit a RRC Reconfiguration Complete message to the currently camped cell;
receive, prior to sending the RRC Reconfiguration Complete message, a second RRC Reconfiguration message; and
ignore the second RRC Reconfiguration message received from the currently camped cell that was received prior to sending the RRC Reconfiguration Complete message.

6. The UE of claim 5, further configured to:
process the full configuration in the first RRC Reconfiguration message prior to sending the RRC Reconfiguration Complete message.

7. The UE of claim 6, wherein the full configuration resets a radio link control (RLC) signaling radio bearer (SRB) for a secondary node (SN).

8. The UE of claim 5, further configured to:
receive, prior to sending the RRC Reconfiguration Complete message, a third RRC Reconfiguration message; and
ignore the third RRC Reconfiguration message received from the currently camped cell that was received prior to sending the RRC Reconfiguration Complete message.

9. A processor of a user equipment (UE), configured to:
receive a first Radio Resource Control (RRC) Resume message comprising a full configuration from a currently camped cell;
transmit a RRC Reconfiguration Complete message to the currently camped cell;
receive, prior to sending the RRC Reconfiguration Complete message, an RRC reconfiguration message; and
ignore the RRC reconfiguration message received from the currently camped cell that was received prior to sending the RRC Reconfiguration Complete message.

10. The processor of claim 9, further configured to:
process the full configuration in the RRC Resume message prior to sending the RRC Reconfiguration Complete message.

11. The processor of claim 10, wherein the full configuration resets a radio link control (RLC) signaling radio bearer (SRB) for a Secondary node (SN).

12. The processor of claim 9, further configured to:
receive, prior to sending the RRC Reconfiguration Complete message, a second RRC reconfiguration message; and
ignore the second RRC Reconfiguration message received from the currently camped cell that was received prior to sending the RRC Reconfiguration Complete message.
